(19) United States
(12) Patent Application Publication
(10) Pub. No.: US 2008/0270306 A1
(43) Pub. Date: Oct. 30, 2008

(54) System and method of theft detection of encoded encrypted software keyed genuine goods

(75) Inventor: Andrew Blencowe, Windham, NH (US)

Correspondence Address: MCINTYRE - LILLEY INTELLECTUAL PROPERTY MANAGEMENT;SERVICES, 2000 SOUTH 2ND STREET, SUITE 12, ARLINGTON, VA, 22204, US

(73) Assignee: ArgSoft Intellectual Property Limited

(21) Appl. No.: 12/149,181

(22) Filed: Apr. 28, 2008

Related U.S. Application Data
(60) Provisional application No. 60/924,039, filed on Apr. 27, 2007.

(51) Int. Cl. G06Q 99/00; H04L 9/00

(52) U.S. Cl. 705/50

(57) ABSTRACT

A system and method of probabilistic determination of the genuiness of goods/articles is provided. A vendor and/or manufacturer creates encrypted software keys. Further, the vendor sells a genuine goods/article. The merchant/customer validates the key by means of secure vendor database of encrypted keys. This validation provides the merchant/customer, along with the vendor/manufacturer with a probabilistic determination of the genuiness of the manufactured/sold good.

### CROSS-REFERENCE TO RELATED APPLICATIONS

This Application is claims the benefit of, and is related to, the following of Applicants' co-pending applications:

U.S. Provisional Application No. 60/924,039 titled “System and Method of Theft Detection of Encoded Encrypted Software Keyed Genuine Goods” filed on Apr. 27, 2007.

### BACKGROUND OF THE INVENTION

1. Field of the Invention

The present invention relates to the field of counterfeit goods identification, data management and tracking.

2. Related Art

Theft of branded goods is widespread worldwide and is endemic in Asia. For example, it is estimated that over 60% of all Louis Vuitton bags in China are not genuine. Until this patent, there has been no effective means of providing any level of assurance. This is especially true when many of the genuine branded handbags are produced in China; these factories are often the source of the fakes as well.

One of the proposed methods of preventing unauthorized use of genuine goods and products is the employment of software encryption keys. This method has been particularly used and applied to software applications.

In the computer software industry it is very common to provide encrypted software keys. The current method of software encryption key to validate authorized use of product is illustrated in FIG. 1 of the PRIOR ART. These encrypted software keys are generated by the vendor's employees at step 102, based on information provided by the customer in step 101. The encrypted software key is then sent to the user/customer in step 103 and the customer applies the encrypted software key to the vendor's software application in step 104. Typically the encrypted software key will prevent the vendor's software product from being run on non-authorized computers.

Moreover, FIG. 2 of the PRIOR ART illustrates a more detailed PRIOR ART process, for the software encryption key validation of software application product.

In step 201, the user is requested to provide and input various user, system and network information, e.g., user identifier, device, and network information. Typical information may include the following:

| | |
|---|---|
| Computer to run on: | CHICAGO_PROD |
| Servers Monitored: | 10 |
| Customer Name: | Acme Tool and Die |

In step 202, the vendor creates an encrypted software key. The software vendor requests and obtains the above detailed information. The vendor then executes a propriety program created and/or owned by the vendor, which processes the customer/user supplied information, along with potentially adding additional information, such as expiration date of the software, customer's e-mail address, creator's name, date of creation, or version of software, etc. An encrypted software key is subsequently created. Thus, the supplied information, when it is inputted into the software program, is used to generate an encrypted software key, e.g., “HR56-GT87-PT84-MR74-DS22”, for example.

In step 203, the vendor sends the encrypted software key to the user. This can be done, upon completion of the encrypted software key and validation by the vendor of the user supplied information. The key can be e-mailed or delivered by means of the conventional mail and shipping system.

With step 204, the customer installs the encrypted software key. After the encrypted software key is e-mailed, or otherwise sent, to the customer, the customer uses the vendor's software application product on the customer's authorized devices, e.g., PC. The encrypted software key is applied to the vendor's software application product. The software product application can be run on either the customer's device, network or even the customer's Internet, Externet or Intranet.

In step 205, the encrypted software key permits the vendor's product to run or to continue to run, if there was a temporary key initially used.

Accordingly, in steps 206a & 206b, if the encrypted software key is authenticated (206a), then the vendor's application is enabled (206b). If the encrypted software key is not authenticated (207a), then the application will become or remain disabled, as indicated in step 207b.

It should be noted that the customer cannot normally decrypt the encrypted software keys. The prior art methods involve key matching techniques, wherein alphanumeric codes are distributed to the receiving party and later verified by the sending party. Therefore, the determination is either validated or not validated, i.e., “YES”/“NO”.

In terms of qualitative determinations of genuineness, the specific manufacturing quality for most branded goods is a relatively ineffective metric given the fact that fake goods can be virtually, if not, in fact, identical to the genuine goods. Therefore, there is a present need for a novel genuineness determination technique. Accordingly, the present invention provides such a system, method and apparatus for such determination.

### SUMMARY OF THE INVENTION

The present invention has been devised to solve the problems associated with the prior art inability to verify the existence of a counterfeit good as described above. More specifically, the present invention is directed toward providing an efficient means of determining the likelihood of the existence of a non-genuine article/good.

To attain the purpose described above, the present invention provides a software encryption key method, database storage and server-based key validation method and apparatus for the probabilistic determination of the genuiness of an article or good.

A major disadvantage of prior art is the lack of an ability to effectively make a genuiness determination, particularly in light of counterfeiters ability to produce fake identifying tags, often identical in appearance and alphanumeric codes.

Therefore, one of the objects of this invention is to improve the determination as to whether or not a non-genuine good exists by making a probabilistic determination of such.

Accordingly, the primary object of the present invention is to provide a system for the authentication of an item comprising a secure server; a database for storing genuiness data regarding predetermined items, wherein said data includes encrypted software keys for said predetermined items. Further, the server automatically makes a genuiness determination for the predetermined items based upon said genuiness data. The genuiness determination is a probabilistic determination based upon a predetermined threshold probability function. The probabilistic determination comprises quantitative and qualitative information. Further, the qualitative information further comprises an authentic description and predetermined geographic destination of said item.

A further object of this invention is to provide a method for the authentication of items comprising, storing genuiness data in a database regarding predetermined items, wherein said data includes encrypted software keys for the items and making a genuiness determination for the predetermined items. The genuiness determination is a probabilistic determination based upon a predetermined threshold probability function. The probabilistic determination comprises quantitative and qualitative information. Further, the qualitative information comprises an authentic description and geographic destination of the item.

These and other objects in advantages of this invention will become apparent when considered in light of the following description and claims when taken together with the accompanying drawings.

### BRIEF DESCRIPTION OF THE DRAWINGS

The accompanying drawings, which are included to provide further the understanding of the present invention and are incorporated in and constitute a part of the specification, illustrating samples of the present invention and together with the description serve to explain the principles of the present invention.

The invention will now be described further with reference to the accompanying drawings in which:

FIG. 1 illustrates a flowchart of a PROIOR ART method of creating a software encryption key.

FIG. 2 illustrates a flowchart of a PROIOR ART method of creating a software encryption key.

FIG. 3 illustrates an embodiment of the present invention's genuiness determination system.

FIG. 4 illustrates a flowchart of an embodiment of the present invention's method of determining genuiness of item up until the step of verification/validation.

FIG. 5 illustrates a flowchart of an embodiment of the present invention's method of determining genuiness of item from the step of verification/validation.

FIG. 6 illustrates an embodiment of the present invention's system for determining genuiness of item.

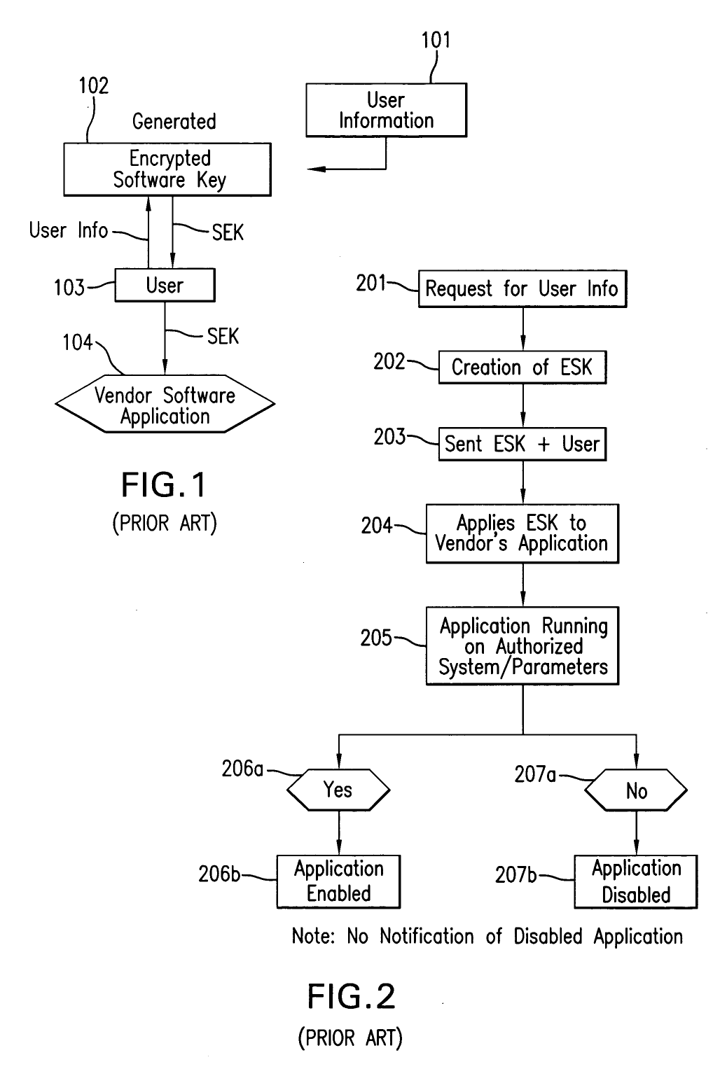

### DETAILED DESCRIPTION OF THE PREFERRED EMBODIMENTS

The following section describes an embodiment of the present invention based on drawings while exemplifying an authentication system and method for genuine goods determination.

The present invention is directed toward a system and method of a user/customer being able to obtain a probabilistic determination as to the genuiness of a specified item, e.g., article, good or product.

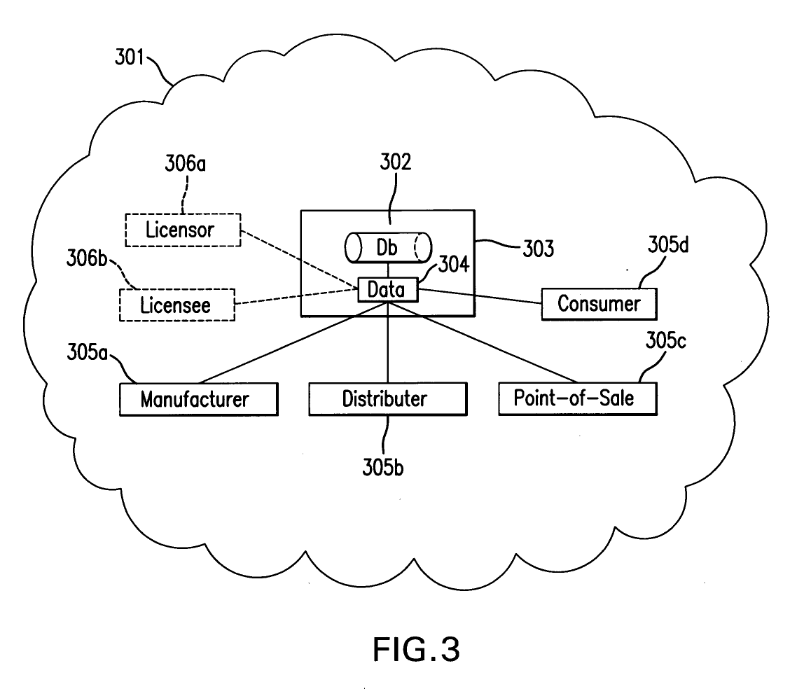

FIG. 3 illustrates the communications network 301 of an embodiment of the present invention. Secure encrypted key information, along with other information regarding the genuine articles of manufacture, i.e., data 304, for individual genuine items is stored in a central database 302, which is stored on a secured server 303. The secured server is accessible by various trusted organizations/individuals. These trusted entities are characterized as backend, front-end and intermediary entities.

The manufacturer 305a and the distributor 305b are backend entities. The manufacturer 305a supplies identifying information for itself and the items. The distributor 305b supplies destination and status information (data 304). The point-of-sale vendor 305c and the purchasing consumer 305d are front-end entities. The point-of-sale vendor 305c inquires into the genuiness of the items it has or will receive, as well as provide unique vendor identifier information, such as date received, purchase price and date, i.e., data 304. The consumer 305d inquires into the genuiness of the item purchased, as well as supplying unique consumer information, such as name, date of purchase, i.e., data 304.

The intermediary entities include genuine item licensor 306a and licensee 306b. Accordingly, the licensor 306a and licensee 306b of the item, e.g., brand name owner, can inquire as to status of the item.

The present invention is directed toward a system and method of a user/customer being able to obtain a probabilistic determination as to the genuiness of a specified article, good or product. Accordingly, when a legitimate vendor creates copies of a specified model of an article or good, e.g., 500 copies of a handbag, these items are subject to being counterfeited for subsequent sale and/or distribution. Often these items are manufactured at one facility and subsequently shipped to alternate locations, e.g., vendor's warehouse, for storage and/or distribution.

It should be noted that the inquirer is both trusted and non-trusted entities. This invention envisions the all of those trusted entities, such as customers, licensors, licensees, manufacturers and distributors, are “users” of the system, along with those non-trusted, e.g., fraudulent purchaser, counterfeiter, etc.

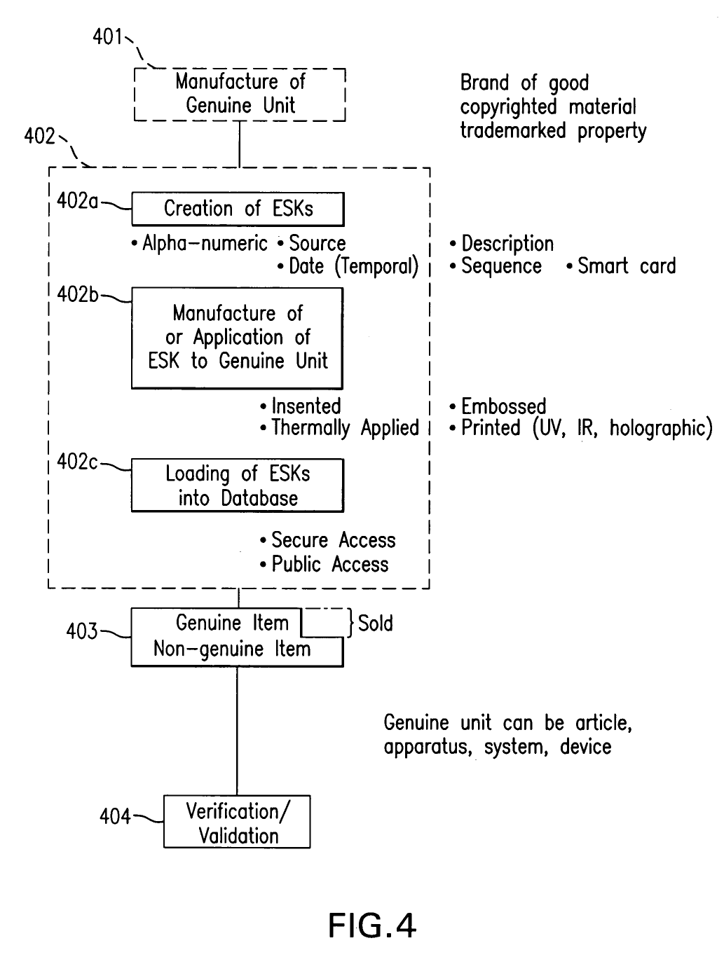

FIG. 4 illustrates a preferred embodiment of the present invention's method of obtaining a determination of genuiness of an item's authenticity. In step 401 a genuine article is manufactured, followed by steps involved in the establishment of the encrypted software keys (step 402). The encrypted software keys are created 402a. The ESKs can be numeric, alpha-numeric, source indicating and temporal (date) related or any combination, thereof The ESKs may also contain descriptive information about the item, manufacturing sequence/serial number. The ESK may be printed onto conventional media or placed in an electronic storage media, such as a smartchip or smartcard, for example. Next in step 402b, the ESK is applied to the genuine item, either inserted or applied. The application can be in the form of thermally applied, holographic, embossed, printed, etc.

In step 402c, the ESKs are loaded into a database for secure access only by trusted entities, although non-trusted entities may attempt such access, but should automatically denied access to the database. As stated above, these trusted entities may include: 1) manufactures, 2) distributors, 3) point-of-sale vendors, 4) consumers, 5) licensors, and 6) licensees.

In step 403, the genuine and non-genuine items are sold. The items may be in article, apparatus, system or device form. Accordingly, a bone fide buyer acquires the genuine good, e.g., handbag, containing a unique encrypted software key. As stated prior, this key can be in the form of a physical key, embossed, printed in visible or non-visible light spectrum ink, even molecular-level or genetic material, e.g. DNA.

Finally, in step 404 at least one trusted entity attempts to verify/validate that an item in question is genuine. Normally, only a consumer, point-of-sale vendor will make a genuiness inquiry. There may be occasion when a distributor needs to make a genuiness, e.g., to check on the authenticity of a shipment received or to be received. Similarly, licensors and licensees may need to inquire into the genuiness of an item, e.g., anti-counterfeiting initiative to “spot-check” items available in the market place to ensure compliance with royalty payment provisions/schedules.

The point-of sale entity, e.g., selling vendor, store, etc., or customer purchasing the good can use a variety of means to check the encrypted software key, such as web browser, 3G telephone, or even calling a vendor's employee at a call center, etc., to validate the key, and thus obtain a probabilistic determination as to whether or not the item is genuine.

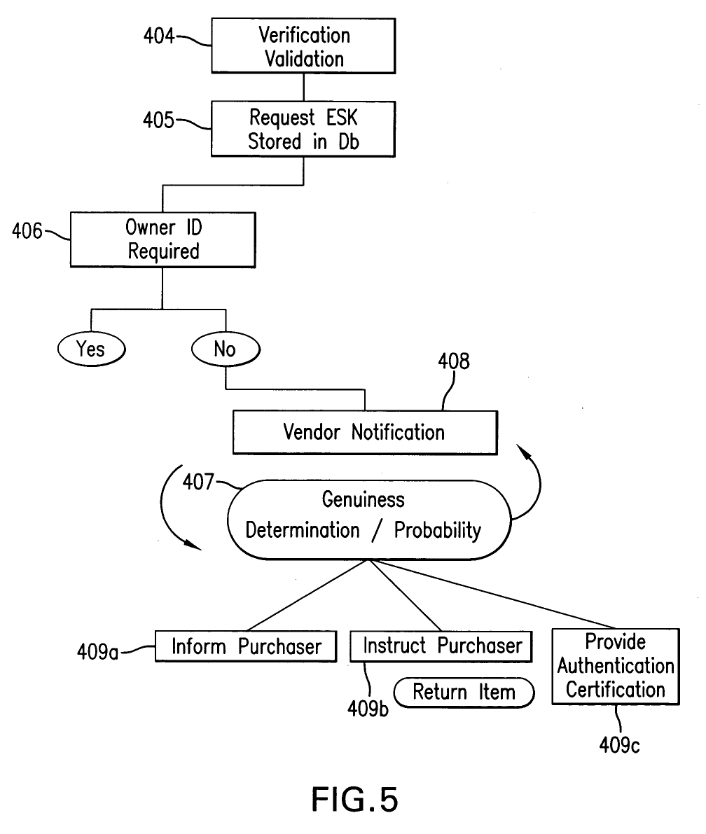

In FIG. 5, which continues the step 404 of verification/validation, a user inquires about a encrypted software key in step 405, unique information about the owner may be required (Step 406), for an added authorization step, which is stored in secure database. The vendor, for example, is notified in step 408 of inquiries and ultimate determinations of determinations. For example, the information may be a combination of color of eyes, height, age, number of siblings, mother's maiden name, biometric information, etc. This information is used, in conjunction with other information regarding the encrypted software key and its associated item, and in further in conjunction with other associated inquires into the genuiness of the item and/or software key, itself, to make a probabilistic determination of genuiness step 407. For example, the information is used to distinguish between two or more inquirers about the same encrypted software key. Thus, step 407 is performed based upon a predetermined threshold probability function.

It should be noted that in addition to vendors, the probabilistic determination is similarly provided to customers, licensors, licensees, manufacturers, and distributors who make a genuiness query, as described above, as in step 408.

The invention also provides instructive notification to the inquirer as to what additional steps to take to inquire further with licensors, licensees, manufacturers, distributors, commercial point-of-sale vendors, to further resolve the issues associated with the probabilistic genuiness determination.

After two or more different ‘owners’ inquire about the same encrypted software key, the present invention determines a probability that all but one, or even perhaps all of these handbags are not genuine. The secure server, based upon instructions provided by the manufacturer, point-of-sale vendor, licensee, etc., informs the inquirer, e.g., purchaser step 409a of the probability that the inquirer's copy may or may not be genuine, and instructs the inquirer as to the appropriate course of action to take as a result of the genuiness determination. For example, the inquirer may be instructed to return, either in person or by mail, the handbag to the store, etc., for further verification stop 409b. In FIG. 5, the inquirer, e.g., customer, is instructed to return the probabilistically determined non-genuine item.

The invention also provides an authenticity certificate step 409c, which is documentation that certifies the genuineness, based upon a probabilistic determination, of the item based upon the item specific information stored within the secure server's database.

Accordingly, the inquirer into the genuineness of the item, e.g., item with associated encrypted software key, is provided with a probabilistic determination as to that genuiness, e.g., the product stands an 80% probability of being genuine. Thus, a predetermined threshold probability function, in this example is set at 80% probability of genuiness by a user, e.g., manufacturer, licensee, etc. Further, the probabilistic determination may include quantitative information, such as percentage likelihood of genuineness. In addition, the probabilistic determination includes qualitative information, such as authentic description of item, intended geographic destination for sale/distribution, etc.

The present invention also utilizes notification that a predetermined threshold probability function for specified counterfeit item codes has been exceeded. This notification is sent to the user/customer and/or the vendor of other specified authorized party. The notification can be in the modes of e-mail, voice, wireless data, facsimile and conventional postal services.

The invention also permits the encrypted key to be grouped into class of codes. Thus, when a particular vendor or manufacturer has begun to experience an increased incidence of probabilistic genuineness determinations indicating, for example a rash of bad codes being entered, the invention notifies the user that there may be a problem with genuineness of the codes or types of goods in question.

Example:

Vendor “ABC”

Item/Product Code
AE12-WR69-YE32-TH67

Probabilistic Determination of Genuiness
January 2004: 14%
February 2004: 13%
March 2004: 15%
April 2004: 12%
May 2004: 67%

From this trend, it can be seen that the probabilistic determination has risen beyond the predetermined threshold probability function, e.g., 50-60%. Further, the invention permits the encrypted software codes to be group in terms of item/product lines, such as a line of pens or CDs. Moreover, the invention provides a comparative analysis of the probability of genuiness for a selected set or even the entire product line of a vendor, i.e., all vendor items. Further, still the invention's comparative analysis includes specified items from all vendors, e.g., pens from multiple pen manufacturers. Thus, the invention permits the user to obtain cross-industry probabilistic determination information regarding genuineness.

Counterfeiters may attempt to circumvent the authentication and verification of encrypted software keys in a number of ways. One of the means is to simply create fictitious encrypted software keys that resemble authentic encrypted software keys, but are simply a random string of letters and digits that match the vendor's encrypted software key pattern. For example, there could be five sets of AAdd, where AA is two letters and dd is two digits. The present invention permits this non-genuineness to be detected when the owner or any point-of-sale entity simply checks the secure database.

Another means of unauthorized distribution of non-genuine goods occurs with the illegal purchase of a genuine item, e.g., a handbag, containing a genuine, valid, encrypted software key and then to duplicate it for a plurality, e.g., 1,000, of non-genuine items, e.g., handbags, that have been created Thus, the same genuine encrypted software key can be used in all 1,000 non-genuine handbags.

In addition, unauthorized distributors may attempt to programmatically harvest real encrypted software keys by making an online attempt, e g., “Internet spoofing”, the database system with key requests, for example starting at AA00-AA00-AA00-AA00-AA00 and ending at ZZ99-ZZ99-ZZ99-ZZ99-ZZ99, as well as other slightly more complex inquires. These types of hacking attempts can be very easily detected by the present invention and can be configured to ignore these requests.

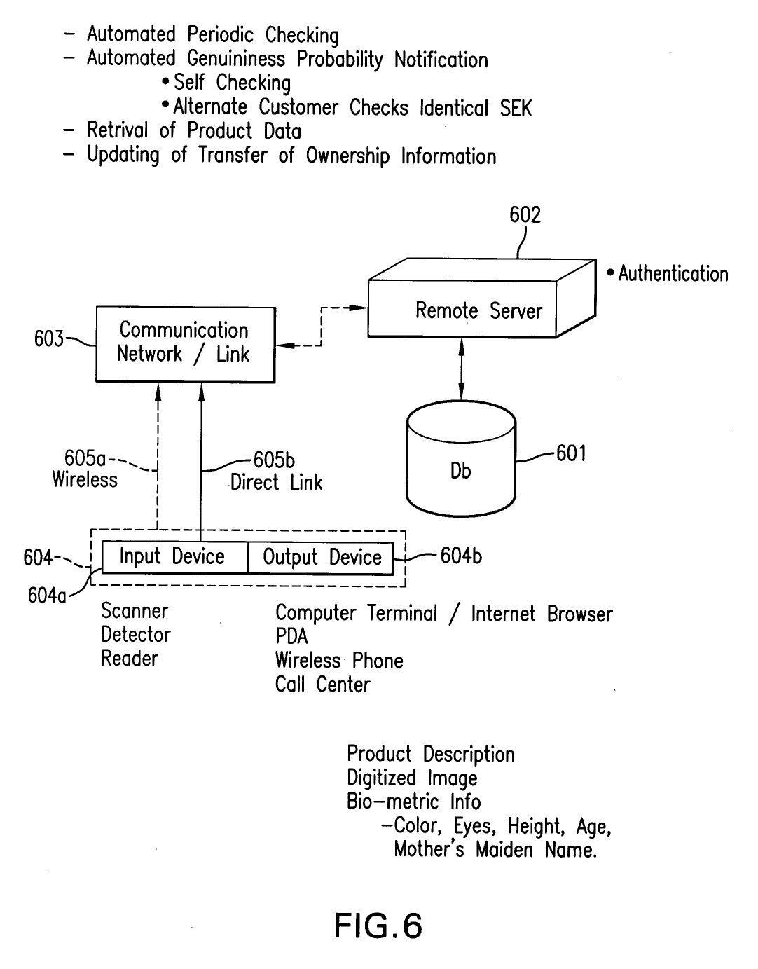

According to FIG. 6, an embodiment of the present invention's apparatus is depicted, wherein a vendor's trusted employees create a plurality, e.g., 500, different encrypted software keys using the encrypted software key generation software program based upon information about source, date, etc., that can be blended with a sequence of 1 to 500 to create 500 different encrypted software keys, for example.

These encrypted software keys are created and associated with each genuine item, e.g., handbag. The handbags can have the encrypted software keys embedded/affixed into them, or otherwise physically attached. The 500 encrypted software keys are inputted and accessed within a secure database 601 the vendor controls. This database is in communication with a secure remote server 602, which is itself coupled to a communication network link 603. Authorized users use access devices 604, encompassing input devices 604a and output devices 604b, to access the database 601, by means of the communication network link 603 and the remote server 602. However, access is only granted to those that are authorized and those so authorized may also be limited in the subject matter or information that they can view and/or manipulate, e.g., an item purchaser is allowed to check the genuiness of his/her item, while also being allowed to add information about his/her item, such as location, time and condition of item at purchase. The access device 605 can access the communications network link directly or indirectly, through either a wireless connection 605a or a direct physical link 605b.

The present invention provides for automated periodic checking/inquiry into the genuiness of goods, along with automated genuiness probability notification. This occurs by the remote server automatically sending information to the output device 604b, along with the automated retrieval of product information from the input device 604a by the remote server. The information retrieved from the access device 604 is transferred to the secure database 601. It should be noted that the access devices can take numerous state-of-the-art forms, such as scanner, detector, reader, computer terminal, Internet browser, personal digital assistant (“PDA”), phone, wireless phone, etc.

It should be noted that this invention encompasses various non-manual, i.e., passive, reading/scanning technologies, such as radio-frequency identification (RFID), wherein the encrypted software key is imbedded in an RFID device, e.g., tag, in addition to the being printed. According to the present invention, when the item, e.g., handbag, is near a receiver, for example in a store or at a national boarder's customs clearance checkpoint for counterfeit goods, an alarm will be raised if the handbag has a predetermined diminished probability of genuiness.

It should be noted that the genuine and non-genuine articles according the present invention may be, in addition to consumer goods, such as handbags or clothing, multi-media products, e.g., CDs, DVDs, etc. Further, the invention includes downloadable digital media, wherein encrypted code is included, readable by the consumer and verifiable according to the system, method and apparatus of the present invention.

Those skilled in the art will recognize that the device and methods of the present invention has many applications, and that the present invention is not limited to the representative examples disclosed herein. Although illustrative, the embodiments disclosed herein have a wide range of modification, change and substitution that is intended and in some instances some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

What is claimed is:

1. A system for the authentication of items comprising;
A secure server;
A database for storing genuiness data regarding predetermined items;
Wherein said data includes encrypted software keys for said predetermined items;
A user access device for accessing said server;
A secure communications link between the server and the user access device;
A secure communications link between said server and said database; and
Wherein the server automatically makes a genuiness determination for the predetermined items based upon said genuiness data.

2. The system according to claim 1, wherein said genuiness determination is a probabilistic determination based upon a predetermined threshold probability function.

3. The system according to claim 2, wherein a notification of a genuiness determination is automatically sent from the server to a user.

4. The system according to claim 2, wherein the probabilistic determination comprises quantitative information.

5. The system according to claim 2, wherein the probabilistic determination comprises qualitative information.

6. The system according to claim 5, wherein said qualitative information further comprises an authentic description and geographic destination of said item.

7. A method for the authentication of items comprising;
Storing genuiness data in a database regarding predetermined items;
Wherein said data includes encrypted software keys for said predetermined items;
Accessing and securely communicating between a user access device and a server by a user access device;
Accessing and securely communicating between said server and said database storing said genuiness data; and
Making a genuiness determination for said predetermined items.

8. The method according to claim 7, wherein said genuiness determination is a probabilistic determination based upon a predetermined threshold probability function.

9. The method according to claim 8, further comprising:
Sending a notification of said genuiness determination from the server to a user.

10. The method according to claim 8, wherein said probabilistic determination comprises quantitative information.

11. The method according to claim 8, wherein said probabilistic determination comprises qualitative information.

12. The method according to claim 11, wherein said qualitative information further comprises an authentic description and geographic destination of said item.
